(19) United States
(12) Patent Application Publication
(10) Pub. No.: US 2026/0158846 A1
(43) Pub. Date: Jun. 11, 2026

(54) VEHICLE SUSPENSION

(71) Applicant: AISIN CORPORATION, Kariya, Aichi (JP)

(72) Inventor: Hiroshi ISONO, Toyota-shi, Aichi-ken (JP)

(73) Assignee: AISIN CORPORATION, Kariya, Aichi (JP)

(21) Appl. No.: 18/724,302

(22) PCT Filed: Nov. 7, 2022
(86) PCT No.: PCT/JP2022/041417

§ 371 Date: Jun. 26, 2024

(30) Foreign Application Priority Data
Mar. 30, 2022 (JP) 2022-056080

(51) Int. Cl. B60G 17/016; B60G 17/015

(52) U.S. Cl. CPC B60G 17/0164; B60G 17/0157; B60G 2202/42; B60G 2400/106

(57) ABSTRACT

A suspension (S) for a vehicle (1) includes a rod-shaped torsion spring (3), an arm (2), a motor (M), and a deceleration unit (G). The torsion spring (3) is rotatably supported by the vehicle (1). The arm (2) extends in a front-rear direction of the vehicle (1) and swingably supports a wheel of the vehicle (1) by using biasing force of the torsion spring (3). The motor (M) is fixed on a side of the vehicle (1). The deceleration unit (G) decelerates rotation of the motor (M), and rotationally drives the torsion spring (3) or a swing shaft (2a) of the arm (2). An output shaft (Z2) of the deceleration unit (G) is provided coaxially with the torsion spring (3) or the swing shaft (2a).

### CROSS REFERENCE TO RELATED APPLICATIONS

This application is a National Stage of International Application No. PCT/JP2022/041417 filed Nov. 7, 2022, claiming priority based on Japanese Patent Application No. 2022-056080 fled Mar. 30, 2022, the entire contents of which are incorporated in their entirety.

### TECHNICAL FIELD

The present disclosure relates to a suspension for a vehicle, for example, in which an arm extending in a front-rear direction of the vehicle in order to support a wheel is swingably supported by a subframe.

### BACKGROUND ART

Conventionally, examples of such a vehicle suspension include one described in the below-indicated Patent Literature (refer to [0008], [0011], [0026] to [0031], and FIG. 1).

This technique is to control a posture of a vehicle by rotationally driving stabilizer bars in a front wheel side stabilizer device being provided between front wheels and a rear wheel side stabilizer device being provided between rear wheels.

Specifically, a housing is provided at an intermediate portion in each of the front and rear stabilizer bars, and a rotational member rotating integrally with the stabilizer bar is arranged within the housing. The rotational members are rotated by supplying and discharging of fluid, and thereby, postures of the stabilizer bars are controlled. The front and rear housings are connected to each other by a plurality of fluid flow paths including a plurality of switching valves. By setting the switching valves, for example, fluid flow generated by rotation of the front side stabilizer bar can rotate the rear side stabilizer bar in the same direction as that of the front side one, or can rotate the rear side stabilizer bar in a direction opposite to that of the front side one.

According to this conventional technique, operating the switching valves enables ascending and descending directions of the front and rear wheels to become the same as or different from each other. In a case of causing the ascending and descending directions to be the same as each other, a pitch posture in a state where the vehicle is traveling straight is maintained. Causing the ascending and descending directions to be opposite to each other can maintain a pitch posture at a time of braking or accelerating the vehicle.

Further, in a state where the vehicle is traveling on a rough road, the fluid connection between the front and rear housings is released by operating the switching valves. Thereby, the front and rear stabilizer bars become free and function as normal stabilizer bars, and thus, rolling motion and the like is appropriately suppressed.

In this manner, according to the above-described conventional technique, a posture of the vehicle is appropriately controlled. Since the fluid flow path is constructed by use of free arrangement of pipes, mountability to the vehicle is satisfactory. Further, the switching valves and the like use the fluid, and thus, generation of an abnormal noise is suppressed, and posture control becomes smoother.

### CITATION LIST

### Patent Literature

Patent Literature 1: JP 2008-80906A

### SUMMARY OF THE DISCLOSURE

### Technical Problem

In the above-described conventional vehicle suspension, the rotational members provided in the front and rear housings are controlled by fluid, and thus, predetermined response time is required. Specifically, the switching valves are operated, fluid flows through insides of the fluid pipes, and the rotational members are then driven, and thus, rotational drive of the rotational members is slow.

In a case of causing fluid to quickly flow, a large pump and accumulator are additionally required, which increases the number of device constituents and requires installation spaces.

Further, the fluid deteriorates over used time, and leakage may occur in the pipes, which makes maintenance work complicated.

Thus, the conventional technique has various problems to be solved, and there has been a need for a vehicle suspension that has a simple structure and is superior in installability and responsiveness of vehicle height control.

### Solution to Problem

### (First Feature Configuration)

A first feature configuration of the present disclosure is a vehicle suspension including a rod-shaped torsion spring, an arm, a motor, and a deceleration unit. The torsion spring is rotatably supported by a vehicle. The arm extends in a front-rear direction of the vehicle, and swingably supports a wheel of the vehicle by using biasing force of the torsion spring. The motor is fixed on a side of the vehicle. The deceleration unit decelerates rotation of the motor, and rotationally drives the torsion spring or a swing shaft of the arm. An output shaft of the deceleration unit is provided coaxially with the torsion spring or the swing shaft.

### (Advantageous Effect)

The present configuration actively drives the torsion spring or the swing shaft of the arm by using the motor, in such a way as to rotate relative to the vehicle, and thus controls a vehicle height of the vehicle and adjusts a damper function. At this time, output of the motor is transmitted to the torsion spring and the swing shaft of the arm via the deceleration unit, and when the output shaft of the deceleration unit and the torsion spring or the like are coaxial with each other, the torsion spring and the swing shaft can be rotationally driven immediately via the output shaft. As a result of this, a body of the suspension including the motor and the deceleration unit is reduced in size. Thus, the device configuration is simple and compact, and the vehicle suspension superior in installability to the vehicle can be implemented.

### (Second Feature Configuration)

The vehicle suspension according to Claim 1, wherein a drive shaft of the motor is provided coaxially with the torsion spring or the swing shaft.

### (Advantageous Effect)

When the drive shaft of the motor and the torsion spring or the like are coaxial with each other, the torsion spring and the swing shaft can be rotationally driven immediately via the output shaft of the deceleration unit. As a result of this, the device configuration becomes simple, the body of the suspension including the motor and the deceleration unit becomes compact, and thus, the vehicle suspension superior in installability to the vehicle can be implemented.

### (Third Feature Configuration)

The vehicle suspension according to the present disclosure has a feature in which the output shaft is connected to an end portion of the torsion spring, and the vehicle suspension includes a lock mechanism locking rotation of the output shaft when electric power is not supplied to the motor.

### (Advantageous Effect)

Locking of rotation of the output shaft by the lock mechanism prevents the output shaft of the deceleration unit from passively rotating by reverse input from the torsion spring and the arm when electric power is not supplied to the motor. Thus, for example, a vehicle height is maintained even in a state where electric power is not supplied to the motor, and the vehicle suspension with a high electric power saving effect can be implemented.

### (Fourth Feature Configuration)

In the vehicle suspension according to the present disclosure, the lock mechanism may be a non-excitation type brake mechanism arranged coaxially with the drive shaft of the motor.

### (Advantageous Effect)

The non-excitation brake mechanism is provided, and thus, even when electric power is not supplied to the motor in traveling state of the vehicle, the output shaft of the deceleration unit can be prevented from rotating or be operated at a predetermined rotational speed, and thus, a vehicle height can be maintained, and a spring constant of the arm can be adjusted. For this reason, an electric power saving effect is enhanced, and a range of property setting of the suspension can be expanded.

### (Fifth Feature Configuration)

In the vehicle suspension according to the present disclosure, the non-excitation type brake mechanism may be the deceleration unit including at least one planetary gear.

### (Advantageous Effect)

With the deceleration unit including the planetary gear, reverse efficiency of drive transmission from the output shaft of the deceleration unit to the drive shaft of the motor is easily set to be small. Thus, for example, a member or the like that engages with one of rotational bodies in the deceleration unit does not need to be separately provided, and merely providing the deceleration unit enables implementation of the vehicle suspension that can easily maintain a vehicle height at a time of non-supply of electric power.

### (Sixth Feature Configuration)

In the vehicle suspension according to the present disclosure, the lock mechanism may include a lock member that is locked in any of rotational members rotating in such a way as to interlock with the drive shaft.

### (Advantageous Effect)

Examples usable as a lock member that can be locked in one of the rotational members rotating in such a way as to interlock with the drive shaft as in the present configuration include a pin member or the like that advances and retracts by using an on-off solenoid, and a configuration of the mechanism is relatively simple. Thus, a vehicle height maintaining function or the like can be provided without significantly changing configurations of the deceleration unit and the motor.

### (Seventh Feature Configuration)

In the vehicle suspension according to the present disclosure, the lock mechanism may be an excitation type electric brake mechanism arranged coaxially with the drive shaft of the motor.

### (Advantageous Effect)

Such an excitation type electric brake mechanism is a brake mechanism that works by being supplied with electric power. The electrically working brake mechanism can lock the drive shaft or the like at any timing, and is expected to achieve a stronger braking effect. Even in a case of providing the electric brake mechanism, installation of the electric brake mechanism can be relatively easy by providing the electric brake mechanism at an end portion that is one of both end portions of the drive shaft and is opposite to the deceleration unit. For this reason, the vehicle suspension that can satisfy various requirements on the brake function and has superior expandability can be implemented.

### BRIEF DESCRIPTION OF DRAWINGS

FIG. 1 illustrates a configuration of a vehicle suspension.

FIG. 2 is a sectional view illustrating a structure of the vehicle suspension according to a first embodiment.

FIG. 3 is a sectional view illustrating a structure of the vehicle suspension according to a second embodiment.

FIG. 4 is a sectional view illustrating a structure of the vehicle suspension according to a third embodiment.

### DESCRIPTION OF EMBODIMENTS

The following describes embodiments of the present disclosure, based on the drawings.

### [Outline]

A suspension S for a vehicle 1 according to the present disclosure includes a suspension arm 2 (hereinafter referred to as “arm 2”) extending in a front-rear direction of the vehicle 1 and swinging by using the elasticity of a torsion spring 3, and includes a motor M actively acting on the torsion spring 3. Examples of the suspension S includes one that can control a vehicle height and one that functions as an active suspension. The following describes embodiments concerning the suspension S for the vehicle 1.

### First Embodiment

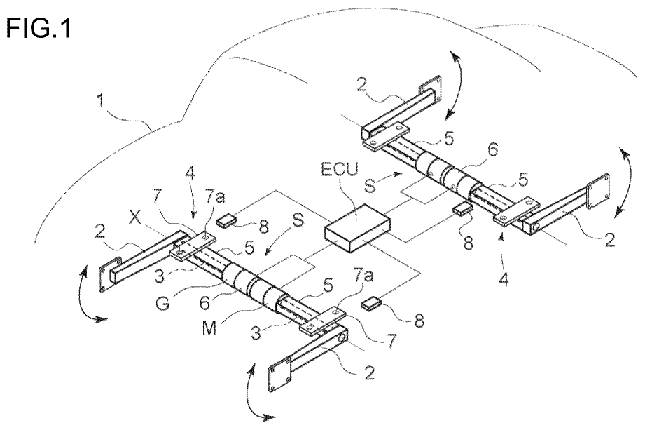

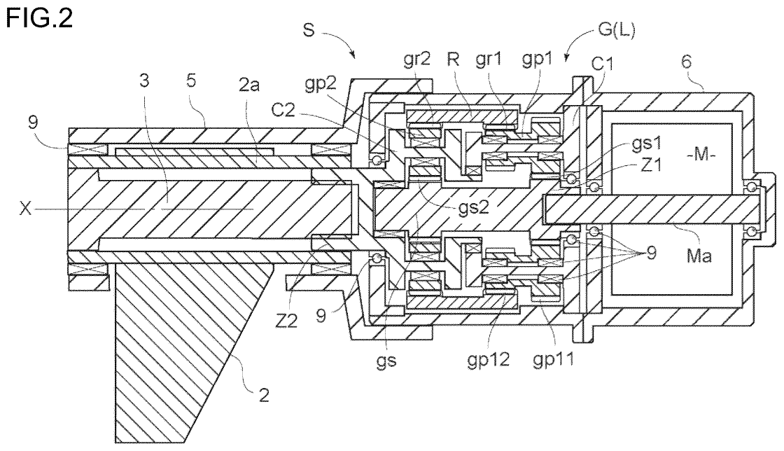

FIG. 1 illustrates an appearance of the suspension S that controls a vehicle height of a vehicle 1. FIG. 2 illustrates a structure of the suspension S. According to the present embodiment, rod-shaped stabilizers 4 are attached to left and right front wheels and left and right rear wheels. The arm 2 that supports the wheel is connected to the stabilizer 4. The stabilizer 4 includes a torsion spring 3, and elastic force of the torsion spring 3 stabilizes up-down movement of the wheel during traveling. Particularly, drive of the motor M actively operates swinging of the torsion spring 3 and the arm 2, and thereby controls a vehicle height. The stabilizers 4 in the present embodiment are independent of each other on left and right sides, and the suspension S of the vehicle 1 is provided at each of the stabilizers 4.

The torsion spring 3 is received inside a swing shaft 2a of the arm 2. One end of the torsion spring 3 is connected to an output shaft Z2 of the below-described deceleration unit G in such a way as to rotate integrally with the output shaft Z2. An opposite end of the torsion spring 3 is fixed to an inner surface of the swing shaft 2a in such a way as to rotate integrally with the swing shaft 2a. One end of the swing shaft 2a is rotatably supported by a subframe 5 via a bearing 9. An inner surface of an opposite end of the swing shaft 2a supports the output shaft Z2 in such a way as to be rotatable relative to the swing shaft 2a, and an outer surface of the swing shaft 2a is supported by the subframe 5 via bearings 9. The subframe 5 is fixed to the vehicle 1. Further, the subframe 5 is provided with the motor M and the deceleration unit G that decelerates rotational drive generated by the motor M and transmits the decelerated rotational drive to the torsion spring 3. The motor M is driven by a drive signal from a control device ECU provided separately in the vehicle 1.

More specifically, the motor M and the deceleration unit G are provided inside a housing 6 fixed to the subframe 5. As illustrated in FIG. 1, the subframe 5 is provided with a fixed portion 7 that is used for being attached to the vehicle 1 and that includes bolt holes 7a, for example. With this configuration, a suspension member including the arm 2 and the subframe 5 is attached to the vehicle 1, and thereby, members including the motor M and the like can also be attached at the same time. Thus, the suspension S for the vehicle 1 superior in attachability to the vehicle 1 can be implemented.

The motor M and the deceleration unit G are fixed to the subframe 5, and thereby, strength of the housing 6 for the motor M and the like, and strength of the subframe 5 can be mutually enhanced. Further, material thicknesses of the housing 6 and the subframe 5 can be reduced, the entire size and the weight can be reduced, and thus, the more practical suspension S for the vehicle 1 can be implemented.

### (Motor)

As illustrated in FIG. 2, an example used as the motor M may be a direct-current brushless motor M driven by a 12V battery. A drive shaft Ma of the motor M is arranged coaxially with the torsion spring 3 constituting the stabilizer 4, and is configured in such a way as to be compact in relation to the subframe 5. In the present embodiment, the drive shaft Ma of the motor M is provided coaxially with the torsion spring 3 and also with the swing shaft 2a. When the drive shaft Ma of the motor M is thus coaxial with the torsion spring 3 and the like, the torsion spring 3 and the swing shaft 2a can be rotationally driven immediately via the output shaft Z2. As a result, a body of the suspension S including the motor M and the deceleration unit G is reduced in size. Thus, the device configuration can be simple and compact, and the vehicle suspension S superior in installability to the vehicle can be implemented.

A type of the motor M is not particularly restricted, but for example, the motor M that can count the number of rotations or the like enables a swing angle of the swing arm 2 to be acquired, and is thus convenient. Using the motor M in this manner enables ascending and descending control with extremely high responsiveness, and enables quick ascending and descending drive of the wheel.

### (Deceleration Unit)

An angle by which the arm 2 swings is slight as compared with a rotation amount of the motor M. Thus, in order to appropriately transmit drive rotation generated by the motor M to the torsion spring 3, the deceleration unit G needs to reduce a rotational speed. However, a configuration of the deceleration unit G is arbitrary, and the deceleration unit G may have any configuration as long as the deceleration unit G can significantly decelerate a relatively fast drive rotation of the motor M and can control changing of a posture of the arm 2 with satisfactory responsiveness.

The deceleration unit G is preferably one in which a reverse input from the wheel to the arm 2 does not rotate the drive shaft Ma of the motor M in a state where electric power is not supplied to the motor M. Thereby, in a state where electric power is not supplied to the motor M, the arm 2 maintains a predetermined basic posture, and thus, a vehicle height maintaining function is exerted Meanwhile, when electric power is supplied to the motor M, an angle of the arm 2 is actively changed, and thus, a vehicle height can be adjusted.

The left and right torsion springs 3 may be coupled to each other in such a way as not to rotate relative to each other when the drive shaft Ma is passively rotated by a reverse input to the arm 2. As a result, when the vehicle 1 is turning while traveling for example, the left and right wheels are prevented from excessively ascending and descending independently of each other, and the stabilizers 4 swing by a predetermined angle as a whole while a relative angle of the left and right arms 2 changes. In other words, in this case, the stabilizers 4 function as general mechanical ones.

An example that can be used as the deceleration unit G is a planetary gear mechanism as illustrated in FIG. 2. Here, rotation of the drive shaft Ma of the motor M is first transmitted to an input shaft Z1 that is connected to the drive shaft Ma in such a way as to rotate integrally with the drive shaft Ma. The input shaft Z1 includes an end portion that is on a side closer to the motor M and that is supported by the housing 6 via a bearing 9, and the input shaft Z1 includes an opposite end portion that is supported by the housing 6 via the below-described output shaft Z2 and a bearing 9.

The input shaft Z1 functions as a sun gear gs, and includes a first sun gear gs1 close to the motor M, and a second sun gear gs2 close to the output shaft Z2. The first sun gear gs1 and the second sun gear gs2 have teeth whose numbers are different from each other, but the difference is set to be slight in many cases.

The first sun gear gs1 meshes with a first planetary gear gp1. The first planetary gear gp1 includes a first-stage gear gp11 and a second-stage gear gp12, and is supported by a first carrier C1 fixed to the housing 6. The number of teeth of the first-stage gear gp11 is different from the number of teeth of the second-stage gear gp12, but the difference in the number of teeth is set to be one to several teeth in many cases. The first sun gear gs1 meshes with the first-stage gear gp11.

Meanwhile, the second-stage gear gp12 meshes with a ring member R arranged on an outer side of the second-stage gear gp12. The ring member R includes a first ring gear gr1 and a second ring gear gr2 each of which is formed as inner teeth, and the second-stage gear gp12 meshes with the first ring gear gr1. The ring member R is rotatable relative to the housing 6. The number of teeth of the first ring gear gr1 is not significantly different from the number of teeth of the second ring gear gr2.

A second planetary gear gp2 meshes with the second ring gear gr2. The second planetary gear gp2 is supported by a second carrier C2 that rotates relative to the housing 6, and a plurality of the second planetary gears gp2 are provided around the axis X of the deceleration unit G. The second sun gear gs2 meshes with the second planetary gears gp2, on a further inner side in the second planetary gears gp2. The second carrier C2 includes an end portion that is on a side of the motor M and that is supported by an end portion of the first carrier C1, and the second carrier C2 includes an opposite end portion as the output shaft Z2 whose outer peripheral surface is supported by the housing 6 via a bearing 9.

In the example represented in the present embodiment, the first carrier C1 out of the first carrier C1 and the second carrier C2 is fixed to the housing 6. However, either one of the first carrier C1 and the second carrier C2 can be fixed to the housing 6 and thereby serves as a reaction force reception portion, and the other of the first carrier C1 and the second carrier C2 is not fixed and can serves as the output shaft Z2 of the deceleration unit G.

In this manner, the first carrier C1 and the second carrier C2 each of which supports the planetary gear gp are configured independently of each other, which thus increases the number of factors concerning adjustment between the gears from the input shaft Z1 to the output shaft Z2. For example, a range of condition selection of a gear train including an idle gear and a gear train including an operation gear is widened as a configuration of meshing between gears necessary for calculating a deceleration ratio. As a result, for example, the one ring gear R can be provided as an additional constituent member, and on this member, the first ring gear gr1 and the second ring gear gr2 can be simultaneously provided, and thus, the constituent member is made to be efficient one, and a considerably large deceleration ratio can be easily set.

In the present embodiment, a rotational direction of the second sun gear gs2 is opposite to a rotational direction of the second ring gear gr2, and the second planetary gears gp2 meshing with these rotate in a direction opposite to the second sun gear gs2. However, the second carrier C2 that rotatably supports the second planetary gears gp2 can be set in such a way as to rotate in either of directions around the axis X, depending on a configuration concerning the number of teeth of each gear.

Particularly, at least any one combination among a combination of the first sun gear gs1 and the second sun gear gs2, a combination of the first-stage gear gp11 and the second-stage gear gp12, and a combination of the first ring gear gr1 and the second ring gear gr2 is set to have mutually different numbers of teeth so that operation setting between the second sun gear gs2 and the second ring gear gr2 becomes easy, and a deceleration ratio from the input shaft Z1 to the output shaft Z2 can be set to be an extremely large arbitrary value.

Among these, setting of the number of teeth of the first sun gear gs1 and the number of teeth of the second sun gear gs2 in the input shaft Z1 means forming of two gears having different numbers of teeth for the one input shaft Z1, and can increase the number of adjustment factors for a deceleration ratio without increasing the number of components. The deceleration unit G having a large deceleration ratio can be implemented without complicating a configuration of the deceleration unit G and without deteriorating the attachability.

In this respect, also in a case of setting the number of teeth of the first ring gear gr1 and the number of teeth of the second ring gear gr2 in the one ring member R, a deceleration ratio can be easily set without increasing the number of components of the deceleration unit G. Particularly, in a case of setting two numbers of teeth in each of the input shaft Z1 and the ring member R, the number of combinations of the numbers of teeth in the respective gears increases, and an entire deceleration ratio can be more easily set.

The number of teeth of each constituent gear is appropriately adjusted by using such a planetary gear mechanism so that a rotational speed of the drive shaft Ma is significantly reduced, and the second carrier C2 as the output shaft Z2 is thus rotated. In other words, the motor M can be rotated at a relatively high predetermined speed, and the arm 2 can be accurately swung by a small swing angle required for adjusting a vehicle height.

According to the deceleration unit G having this configuration, when a reverse input acts on the output shaft Z2 from the arm 2, each gear of the deceleration unit G and the drive shaft Ma of the motor M is hardly caused to passively rotate. Thus, this deceleration unit G also functions as a locking mechanism L for the end portion of the torsion spring 3, and a satisfactory vehicle height maintaining function is exerted even when electric power is not supplied to the motor M. In this case, the lock mechanism L serves as a non-excitation type brake mechanism. Providing such a deceleration unit G enables electric power saving of the suspension S for the vehicle 1, enhances reverse efficiency of the motor M and the deceleration unit G, and further enables a capacity of the motor M to be reduced.

Meanwhile, in a case of changing a vehicle height, the motor M is driven, and thereby, the arm 2 is swung by a predetermined angle. A swing angle of the arm 2 is calculated by the control unit ECU, based on a rotational speed and drive time of the motor M, or based on a rotational angle and the like of the motor M.

Depending on a configuration of each gear of the planetary gear mechanism, the second carrier C2 including the output shaft Z2 of the deceleration unit G rotates by a reverse input from the arm 2 in some cases. In order to maintain a vehicle height in this case, electric power may be supplied to the motor M, and thereby, the motor M may generate predetermined drive force that can resist the reverse input. In this case, the lock mechanism L is an excitation type electric brake mechanism.

### (Stabilizer)

In the configuration illustrated in FIG. 2, the axis of the drive shaft Ma of the motor M and the axis of the output shaft Z2 of the deceleration unit G coincide with the axis of the torsion spring 3. These are referred to as the axis X. With this configuration, a transmission path of the rotational drive force from the motor M to the torsion spring 3 is efficiently configured, and the torsion spring 3 can be driven immediately via the output shaft Z2. Thus, the suspension S for the vehicle 1 whose number of components is small and whose entire configuration is compact can be implemented.

Since the housing 6 is fixed to the subframe 5 and these are integrally attached to the vehicle 1, the stabilizer 4, the motor M, and the deceleration unit G are integrally and compactly configured, and the attachability to the vehicle 1 is also improved.

In the present embodiment, such a motor M and a deceleration unit G are provided in the stabilizer 4 for each of the front wheels and the rear wheels. These front and rear motors M are driven and controlled by the control unit ECU. For example, driving and controlling the motors M at only one of the front and the rear enables a pitch posture of the vehicle 1 to be easily adjusted. Naturally, driving and controlling the front and rear motors M in opposite directions enables a pitch posture of the vehicle 1 to be adjusted more quickly. Controlling the front and rear motors M in the same direction enables a vehicle height of the vehicle 1 to be adjusted.

In a case of driving and controlling the motor M, monitoring the number of rotations of the motor M and input electric power to the motor M enables an amount of work of the motor M to be determined, and enables an ascending or descending state of the stabilizer 4 to be distinguished. However, only the drive information acquired from the motor M merely enables a posture of the vehicle 1 to be estimated, and there is a possibility that only the drive information does not enable an actual posture to be recognized. In view of it, a vehicle height sensor 8 is provided at one or more locations in the vehicle 1, and a control amount of the motor M is compared with a detected value of the vehicle height sensor 8 so that a posture of the vehicle 1 can be more accurately controlled.

As illustrated in FIG. 1, for example, an acceleration sensor that detects acceleration of an up-down movement of the vehicle 1 may be used as the vehicle height sensor 8, and may be provided at each of a total of three locations that consist of respective locations in the vehicle 1 and close to the front-side left and right wheels and a location in the vehicle 1 and close to either one of the rear-side left and right wheels or close to the rear suspension S. Since up-down positions of the wheels relative to the vehicle 1 are adjusted by the motors M, ascending and descending of the wheels are adjusted more accurately by detecting up-down movements of the locations among parts of the vehicle 1 and close to the wheels.

Using the vehicle height sensor 8 enables the vehicle 1 to be controlled horizontally by calculating a pitch rate and a pitch angle of the vehicle 1, in various traveling states such as one when the vehicle 1 is accelerating, one when the vehicle 1 is decelerating, or one when the vehicle 1 is traveling on a rough road.

### Other Embodiments

<1>

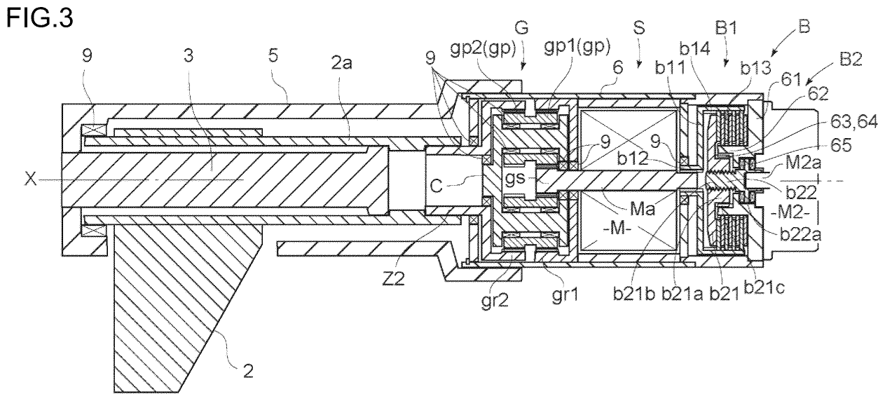

FIG. 3 illustrates a second embodiment of the suspension S for the vehicle 1 that functions as an active suspension. Here, in addition to the motor M and the deceleration unit G, a damping unit B is provided coaxially with the drive shaft Ma of the motor M. The damping unit B deals with passive rotation of the drive shaft Ma caused by a reverse input acting on the arm 2, and appropriately controls rotation of the drive shaft Ma and the output shaft Z2 of the deceleration unit G.

The torsion spring 3 is received inside the swing shaft 2a of the arm 2, and one end of the torsion spring 3 is fixed to the subframe 5. An opposite end of the torsion spring 3 is fixed to the swing shaft 2a. The swing shaft 2a includes one end rotatably supported by the subframe 5 via a bearing 9, and includes an opposite end externally fitted onto the output shaft Z2.

### (Deceleration Unit)

The deceleration unit B in the second embodiment may have the following configuration, for example. Here, the drive shaft Ma of the motor M serves as the sun gear gs, and the planetary gear gp meshes with the sun gear gs. The planetary gear gp has a two-stage configuration including the first-stage gear gp1 and the second-stage gear gp2. Among them, the first-stage gear gp1 meshes with the inner teeth of the first ring gear gr1 fixed to an inner surface of the housing 6, and decelerates and rotates the carrier C in the same rotational direction as that of the sun gear gs, accompanying rotation of the sun gear gs. Reverse efficiency of drive transmission from the output shaft Z2 of the deceleration unit G to the drive shaft Ma of the motor M is easily set to be small, by constituting the deceleration unit B by the planetary gear mechanism.

Next, the second ring gear gr2 including the inner teeth is rotated via the second-stage gear gp2 of the planetary gear gp, based on rotation of the carrier C and rotation of the planetary gear gp. The second ring gear gr2 rotates in the same direction as the drive shaft Ma does. The second ring gear gr2 includes a smaller-diameter boss portion at a part other than the inner teeth, and this boss portion serves as the output shaft Z2. The outer surface of the output shaft Z2 is supported by the housing 6 via the bearing 9. The inner surface of the output shaft Z2 rotatably supports the end portion of the carrier C via the bearing 9, and engages with the swing shaft 2a of the arm 2.

As illustrated in FIG. 3, the damping unit B is provided on an opposite side of the deceleration unit G with respect to the motor M interposed between the damping unit B and the deceleration unit G. The damping unit B includes a brake unit B1 that brakes the drive shaft Ma of the motor M, and a brake drive unit B2 that switches the brake unit B1 between a braked state and a released state. The housing 6 that receives the motor M inside extends to an opposite side of the deceleration unit G, and the brake unit B1 and the brake drive unit B2 are provided inside such an extending portion of the housing 6.

The brake unit B1 includes a cup-shaped body b11 that rotates integrally with the drive shaft Ma of the motor M. A boss portion b12 extending toward the drive shaft Ma is formed at one end portion of the body b11. The drive shaft Ma is fitted into an inner surface of the boss portion b12, and an outer surface of the boss portion b12 is rotatably supported by the housing 6 via a bearing 9.

Inside a tubular wall portion of the body b11, a plurality of annular friction plates b13 are arranged side by side along an extending direction of the drive shaft Ma. A plurality of the friction plates b13 of two types are provided, and for example, and include ones each including an outer peripheral edge provided with at least one notch, and this notch engages with an outer convex portion b14 that is formed on an inner surface of the tubular wall portion of the body b11 in such a way as to extend along the extending direction of the drive shaft Ma. Thereby, the friction plates b13 rotate in a state of interlocking with the body b11, and are movable relative to the body b11 along the extending direction of the drive shaft Ma.

Others of the friction plates b13 each include an inner peripheral edge provided with at least one notch, and this notch engages with an inner convex portion 63 that is provided on a surface of a boss portion 62 protruding from a bottom portion 61 of the housing 6. Thereby, such friction plates b13 do not rotate relative to the housing 6, but are movable along the extending direction of the drive shaft Ma.

### (Brake Drive Unit)

These friction plates b13 are braked by the brake drive unit B2. A disk-shaped pressing plate b21 contacts against the friction plate that is among the friction plates b13 and that is closest to the motor M. The pressing plate b21 includes an annular pressing portion, and presses a plurality of the friction plates b13 in such a way as to contact against each other and thereby generate friction force. A female screw portion b21b provided along the extending direction of the drive shaft Ma is formed on an inner surface of a boss portion b21a that is provided at a center portion of the pressing plate b21. Meanwhile, at least one convex portion b21c along the extending direction of the drive shaft Ma is formed on an outer surface of the boss portion b21a. The convex portion b21c engages with a groove portion 64 formed on an inner surface of the boss portion 62 of the housing 6, and thereby, the pressing plate b21 is movable along the extending direction of the drive shaft Ma without rotating.

A rod-shaped pulling member b22 is screwed into the female screw portion b21b of the pressing plate b21. The pulling member b22 includes, at one end portion thereof, a male screw portion screwed into the female screw portion b21b of the pressing plate b21, and includes an opposite end portion engaging with a second drive shaft M2a of the below-described second motor M2. This opposite end portion is provided with a flange portion b22a for example, and the flange portion b22a is sandwiched between a step portion 65 formed on an inner surface of the boss portion 62 and an end surface of the second motor M2 so that the pulling member b22 is restricted from moving along the axis Ma.

With these, switching a rotational direction of the second motor M2 causes pressing force between the friction plates b13 to be increased or decreased by movement of the pressing plate b21 along the axis X. Thereby, the drive shaft Ma of the motor M and the output shaft Z2 of the deceleration unit G can be set to be in a braked state or a released state. Using the pulling member b22 can implement the brake drive unit B2 for which no concern about the buckling exists and that can generate large drive force while sizes and weights of the components can be reduced.

The brake drive unit B2 thus includes the second electric motor M2, and thereby, swinging of the arm 2 to be suppressed can be quickly and reliably suppressed at an appropriate timing, and a posture of the suspension S can be controlled to be in an appropriate state, depending on a traveling state of the vehicle 1.

A configuration including the friction plates b13 and the like having the above-described configuration is relatively simple. Thus, pressing force applied to the friction plates b13 can be easily set, and a size and a material of the friction plates b13 can also be set appropriately.

Such a damping unit B can be relatively easily provided at an end portion that is one of both end portions of the drive shaft Ma and that is on an opposite side of the deceleration unit G. Thus, function expandability of the vehicle 1 that uses the suspension S for the vehicle 1 including the motor M and the deceleration unit G can be enhanced.

Further, when the axis of the brake unit B1 is the axis X coaxial with the torsion axis of the torsion spring 3 and the axis of the drive shaft Ma, a relation between a swinging speed of the arm 2 and a rotational speed of the brake unit B1 can be easily acquired, and braking force applied to the brake unit B1 can be easily set. A structure in which the brake unit B1 cooperates with the torsion spring 3 can be easily made, and the damping unit B having the simple and compact structure can be implemented. Thus, providing the damping unit B1 of the present configuration can implement the reasonable and low-cost damping unit B.

The pulling member b22 is operated by the brake drive unit B2, based on a correlation set between a swinging speed of the arm 2 and operating force applied to the friction plates b13 by the brake drive unit B2, for example. A swinging speed of the arm 2 out of these can be acquired, for example, from a value detected by the vehicle height sensor 8 attached to the vehicle 1 and detection of a rotational speed or the like of the drive shaft Ma of the motor M or any of the rotational members included in the deceleration unit G and rotating in such a way as to follow the arm 2.

The operating force applied to the one friction plate b13 can be appropriately set, for example, by detecting a rotational angle and a rotational load of the second drive shaft M2a of the second motor M2, or a rotation angle and the like of the drive shaft Ma of the motor M for vehicle height control and thereby recognizing a pressing state between the pressing plate b21 and the friction plates b13. A correlation between a swinging speed of the arm 2 and the operating force applied to the friction plate b13 by the brake drive unit B2 may be previously adjusted and stored in the control unit ECU.

In a case of the present configuration, for example, when the vehicle 1 travels on a bumpy road surface and a swinging speed of the arm 2 thus increases, the friction plates b13 are strongly pressed, an effect of suppressing rotation of the arm 2 is enhanced, and fluttering of the suspension S is suppressed. When the vehicle 1 is turning at a high speed, a front portion of the vehicle 1 on an turning outer side significantly sinks in some cases, but this movement is also suppressed so that a turning posture of the vehicle 1 is stabilized. Thus, providing the brake drive unit B2 enables a traveling property of the vehicle 1 to be easily improved.

In order to optimally control a swinging angle of the arm 2 or reliably stop excessive swinging of the arm 2, magnitude of braking force generated in the brake unit B1 needs to be easily adjustable. In the present embodiment, the deceleration unit G is provided between the swing shaft 2a and the brake unit B1, and each gear of the deceleration unit G rotates when swinging of the arm 2 is transmitted to the brake unit B1. In this case, a swinging angle of the arm 2 is amplified by the deceleration unit G and then transmitted to the brake unit B1. In other words, the deceleration unit G in the present embodiment functions also as an amplification mechanism that increases a rotational angle of the torsion spring 3 based on swinging of the arm 2.

Thereby, a rotational speed of the friction plates b13 of the brake unit B1 becomes appropriately high, and braking force generated by the brake drive unit B2 can be easily adjusted. When a swinging rotation of the arm 2 is amplified by the deceleration unit G, and the drive shaft Ma of the motor M is thus rotated, the motor M can be used as a regeneration device. Thus, the damping unit B with a high added value can be implemented.

<2>

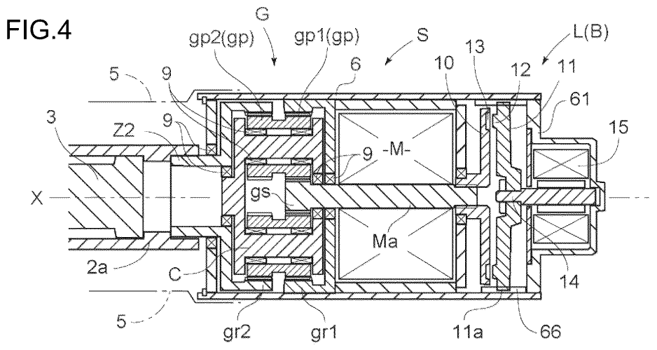

FIG. 4 illustrates a third embodiment of the suspension S for the vehicle 1. This embodiment is also an active suspension. Here, a lock mechanism L is provided instead of the brake unit B1 and the brake drive unit B2 in the device illustrated in FIG. 3. The lock mechanism L is also one form of the damping unit B. Specifically, a plate-shaped locked plate 10 as a rotational member is connected to an end portion of the drive shaft Ma of the motor M in such a way as to rotate integrally with this end portion. A plate-shaped locking plate 11 as a lock member is configured in such a way that along the axis X, the locking plate 11 can be brought into a state of locking the locked plate 10 and be detached from the locked plate 10. The locking plate 11 is operated by a solenoid 15.

A claw portion 12 and a hole portion 13 that engage with each other are formed at the locking plate 11 and the locked plate 10, respectively. These are locked by and released from each other by the solenoid 15 pushing and pulling an operation shaft 14 provided at the center of the locking plate 11. The control unit ECU instructs working of the solenoid 15, depending on a traveling state of the vehicle 1.

At least one notch 11a is provided on an outer peripheral portion of the locking plate 11, and is engaged with a convex portion 66 formed, along the axis X, on an inner surface of the housing 6. Thereby, the locking plate 11 reciprocates relative to the housing 6 without rotating. Although not illustrated in FIG. 4, for example, a biasing member may be provided, and causes the claw portion 12 and the hole portion 13 to be locked by each other or separated from each other in a state where electric power is not supplied to the solenoid 15.

The claw portion 12 and the hole portion 13 may have an arbitrary shape. For example, the claw portion 12 and the hole portion 13 can have any of various shapes such as a rectangular-parallelepiped shape, a triangular-prism shape, and a semi-cylindrical shape. In a case of the rectangular-parallelepiped shape, in a state where both of these portions are locked by each other, the locked state of both of these portions is hardly released even when rotational force acts on the locked plate 10. When surfaces for the locking of both of these portions have a shape such as the triangular-prism shape that has an angle with respect to a rotational direction of the locked plate, the locked state of both of these portions is easily released by a reverse input acting on the locked plate 10. In other words, a shape that prevents both of these portions from being unexpectedly unlocked can be arbitrarily selected by taking into consideration force by which a reverse input acting on the arm 2 causes rotation of the locked plate 10 via the deceleration part G and the drive shaft Ma and force by which the solenoid 15 causes the claw portion 12 and the hole portion 13 to be pressed against each other.

The claw portion 12 and the hole portion 13 may be always locked by each other when the vehicle 1 is traveling, or may be unlocked at normal time. For example, the non-locking state may be set in a case where at normal traveling, a reverse input transmitted from the arm 2 does not cause passive rotation of the drive shaft Ma of the motor M because of efficiency of the deceleration unit G. However, when the vehicle 1 is traveling on a rough road, an input signal from the vehicle height sensor 8 causes the claw portion 12 and the hole portion 13 to be brought into a locked state. Thereby, a rotational phase of an end portion of the torsion spring 3 does not change, and a vehicle height is reliably maintained.

When a reverse input from the arm 2 easily causes rotation of the drive shaft Ma because of a property of the deceleration unit G, the claw portion 12 and the hole portion 13 are set in a locked state, and thereby, a vehicle height maintaining function is exerted.

Providing the locked plate 10 and the locking plate 11 as in the present configuration is relatively easy, and enables a configuration of the device to be made compact without a problem concerning a strength. Thus, a highly reliable vehicle height maintaining function can be easily added to the suspension S including the torsion spring 3 and the arm 2.

<3>

A wave gear mechanism (not illustrated) having a large deceleration rate of a rotational speed can also be used as the deceleration unit G of the suspension S for the vehicle 1, instead of the planetary gear mechanism illustrated in FIG. 1. Even the wave gear mechanism can be arranged at the subframe 5 coaxially with the torsion spring 3, and enables the compact suspension S or damping unit B in the vehicle 1 to be implemented.

In the example illustrated in FIG. 3, the friction plates b13 are braked by drive of the second motor M2, but instead of this, the friction plates b13 may be pressed against each other by using any of various biasing members at normal time so that constant friction force is always generated.

In the present configuration, depending on setting of biasing force, the friction plates b13 rotate slowly relative to each other in response to up-down movement of the arm 2 in normal traveling in some cases, and an effect of suppressing up-down movement of the arm 2 is reduced. However, at the time of traveling on a bumpy road surface, an effect of friction between the friction plates b13 is exerted when the arm 2 swings at an acceleration equal to or higher than a predetermined value, and intense up-down movement of the arm 2 is suppressed to be within a predetermined range. Thus, even the present configuration can implement the suspension S for the vehicle 1 that has a traveling property superior in impact absorption.

The motor M and the deceleration unit G do not need to be arranged coaxially with the swing shaft 2a and the torsion spring 3, and the swing shaft 2a and the drive shaft Ma of the motor M may mesh with each other by spur gears or the like. The housing 6 that receives the motor M and the deceleration gear G inside may be attached to the vehicle 1 instead of being attached to the subframe 5.

The vehicle suspension according to the present disclosure can be used widely in any of vehicles each including a suspension that can be driven by a motor and in which an arm supporting a wheel is provided in association with a torsion spring.

### REFERENCE SIGNS LIST

1 Vehicle
2 Arm
2a Swing shaft
3 Torsion spring
10 Rotational member
11 Lock member
G Deceleration unit
gp Planetary gear
L Lock mechanism
M Motor
Ma Drive shaft
S Suspension
Z2 Output axis

1. A vehicle suspension comprising:
a rod-shaped torsion spring being rotatably supported by a vehicle
an arm that extends in a front-rear direction of the vehicle and swingably supports a wheel of the vehicle by using biasing force of the torsion spring;
a motor being fixed on a side of the vehicle and
a deceleration unit that decelerates rotation of the motor, and rotationally drives the torsion spring or a swing shaft of the arm, wherein
an output shaft of the deceleration unit is provided coaxially with the torsion spring or the swing shaft.

2. The vehicle suspension according to claim 1, wherein
a drive shaft of the motor is provided coaxially with the torsion spring or the swing shaft.

3. The vehicle suspension according to claim 1, wherein
the output shaft is connected to an end portion of the torsion spring, and the vehicle suspension further comprises a lock mechanism that locks rotation of the output shaft when electric power is not supplied to the motor.

4. The vehicle suspension according to claim 3, wherein
the lock mechanism is a non-excitation type brake mechanism arranged coaxially with the drive shaft of the motor.

5. The vehicle suspension according to claim 4, wherein
the non-excitation type brake mechanism is the deceleration unit including at least one planetary gear.

6. The vehicle suspension according to Claim wherein
the lock mechanism includes a lock member being locked in any of rotational members rotating in such a way as to interlock with the drive shaft.

7. The vehicle suspension according to claim 3, wherein
the lock mechanism is an excitation type electric brake mechanism arranged coaxially with the drive shaft of the motor.
